(19) United States
(12) Patent Application Publication
(10) Pub. No.: US 2025/0061433 A1
(43) Pub. Date: Feb. 20, 2025

(54) SYSTEMS AND METHODS FOR NETWORKING USER ACCOUNT DATA BETWEEN DIFFERENT ENTITIES

(71) Applicant: Stripe, Inc., South San Francisco, CA (US)

(72) Inventors: Daniel Edward KNUDSEN, Seattle, WA (US); Victoria MARTINEZ, Brooklyn, NY (US); Tyler DOSS, San Francisco, CA (US); Alberto DE PABLO RODRIGUEZ, New York, NY (US); Bimeng GONG, Seattle, WA (US)

(21) Appl. No.: 18/235,790

(22) Filed: Aug. 18, 2023

(51) Int. Cl. G06Q 20/08; H04L 9/40

(52) U.S. Cl. CPC G06Q 20/0855; H04L 63/0884

(57) ABSTRACT

A service provider server establishes a link to network (e.g., share) and reduce steps to complete a transaction between an electronic device of a user and a third party server. When the user, via their electronic device, accesses a service provider server to conduct a transaction between the user and the third party server, the service provider server may store the user account data and/or access information for accessing the user account data, received from a financial institution, as a link. When the user, via their electronic device, accesses the service provider server again to transact with a subsequent third party server, the service provider server may receive a request from the subsequent third party server for user account data. The service provider server may use the link to provide other third parties with the user account data, subject to one or more conditions imposed on the payment provider.

### TECHNICAL FIELD

The present description generally relates to payment systems, and more particularly, to networking a payment-based link, initially established with an entity, to other entities.

### BACKGROUND

A user may perform an online, computer-based payment to an entity (e.g., merchant or other business) using a bank account owned by the user. If account information from the bank account is saved by a payment provider, the user may perform a subsequent online payment to other entities using the payment provider.

### BRIEF DESCRIPTION OF THE DRAWINGS

Certain features of the subject technology are set forth in the appended claims. However, for the purpose of explanation, several implementations of the subject technology are set forth in the following figures.

FIG. 1 illustrates an example of a network environment of a payment processing system in which a link may be used to perform a payment transaction to various entities, in accordance with one or more implementations.

FIG. 2 illustrates a block diagram of an example electronic device, in accordance with one or more implementations.

FIG. 3 illustrates exemplary data fields of example link data corresponding to a link, in accordance with one or more implementations.

FIG. 4 illustrates an example process flow for providing an established link to a third party, in accordance with one or more implementations.

FIG. 5 illustrates a block diagram of a payment provider capable of networking a link based on one or more conditions, in accordance with one or more implementations.

FIG. 6 and FIG. 7 illustrate respective flowcharts showing various processes that may be conducted by a payment provider, in accordance with one or more implementations.

FIG. 8 illustrates an example electronic system with which aspects of the present disclosure may be implemented, in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

The subject technology is directed to enabling a service provider, e.g., a payment provider, to network (e.g., share, reuse) a link previously established with a user's account (e.g., a financial account at a financial institution). A “link” may correspond to a set of one or more networkable data fields stored by a payment provider in which authentication information is capable of being shared for the purposes of completing transactions with a third party (e.g., a business with which the user transacts). By storing the link, the payment provider may offer users with the benefit of sharing the link (e.g., authentication information) with various third parties without the user having to log into the user's account for each transaction with each third party. A “data field” may refer to user account data associated with a user account, such as a financially related trait of a user account or other financial information associated with the user account. As a non-limiting example, a data field may include an account number and a routing number for a user account.

In one or more implementations, for the link to be networkable, several conditions may be imposed on the payment provider. For example, the data field(s) of the link must be permitted for networking via the link based on access controls and/or restrictions set forth by the financial institution holding the user's account. In some embodiments, the access controls and/or restrictions may be based on terms that are agreed to by the parties. In some embodiments, the parties may include the financial institution, a merchant, a payment provider, a customer, a vendor, a user, or another third party. Additionally, the data field(s) must be technically supported for networking. For example, a protocol for linking the data field must be in place and available to the payment provider. Further, the link cannot be “broken” or inoperable, e.g., the data field(s) must be capable of being correctly and accurately retrieved and/or updated by the payment provider when communicating with the institution and/or the third party. In one or more implementations, the payment provider may self-impose a condition that requires all of the rules and restrictions be satisfied, thus requiring the payment provider to adhere with the most restrictive possible set of circumstances, prior to authorizing the link to be networked to third parties.

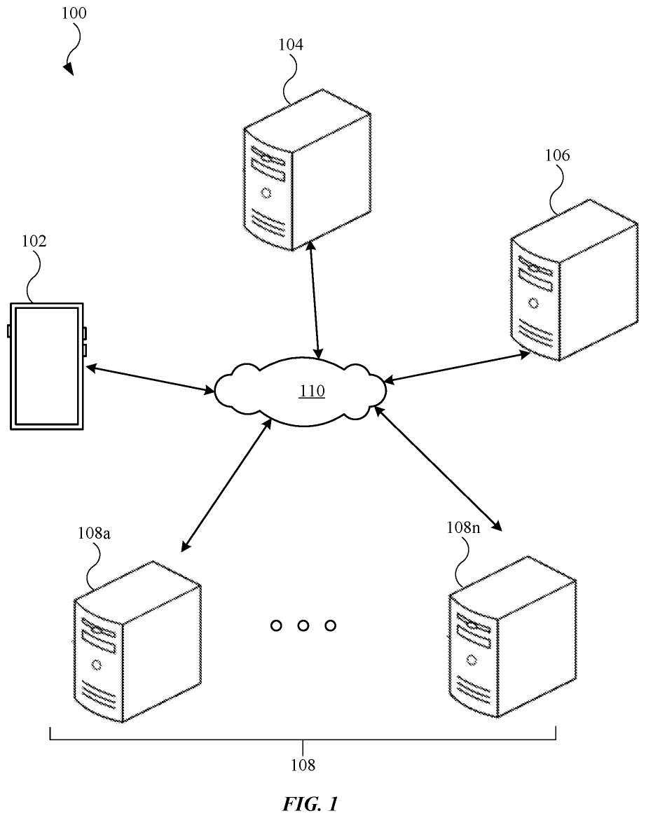

FIG. 1 illustrates an example of a network environment 100 of a payment processing system in which a link may be used to perform a payment transaction to various entities. Not all of the depicted components may be used in all implementations, however, and one or more implementations may include additional or different components than those shown in FIG. 1. Variations in the arrangement and type of the components may be made without departing from the spirit or scope of the claims as set forth herein. Additional components, different components, or fewer components may be provided.

The network environment 100 may include an electronic device 102, a service provider server 104, a financial institution server 106, and one or more third party servers 108 (e.g., a third party server 108a through a third party server 108n, representing n third parties). The network environment 100 may further include a network 110 communicatively (directly or indirectly) coupled with one or more of the electronic device 102, the service provider server 104, the financial institution server 106, and the one or more third party servers 108. In one or more implementations, the network 110 may be an interconnected network of devices that may include, or may be communicatively coupled to, the Internet. For explanatory purposes, the network environment 100 is illustrated in FIG. 1 as including the electronic device 102, the service provider server 104, the financial institution server 106, the one or more third party servers 108, and the network 110. However, the network environment 100 may include any number of electronic devices and/or any number of servers communicatively coupled to each other directly or via the network 110.

The electronic device 102 may take the form of, for example, a wearable device such as a watch (or smartwatch), a desktop computer, a portable computing device (e.g., a laptop computer, a smartphone, a peripheral device such as a digital camera or headphones, a tablet device), or any other appropriate device that includes, for example, one or more wireless interfaces, such as WLAN radios, cellular radios, Bluetooth radios, Zigbee radios, near field communication (NFC) radios, and/or other wireless radios. In FIG. 1, by way of example, the electronic device 102 is depicted as a smartphone. Also, the communication among the service provider server 104, the financial institution server 106, and the one or more third party servers 108 may be through respective servers of the service provider server 104, the financial institution server 106, and the one or more third party servers 108.

The service provider server 104 may include a payment provider. In this regard, the service provider server 104 may include a payment processing platform that provides a variety of payment-based services for a user interacting with the service provider server 104 through the electronic device 102. As non-limiting examples, the service provider server 104 may send payments on behalf of users and third parties, accept payments on behalf of users and third parties, receive requests from users or third parties to process a payment, and manage business activities for users and third parties. Further, the user may interact with the service provider server 104 by one or more of a software application, or app, running on the electronic device 102 or a website running on a web browser on the electronic device 102.

The financial institution server 106 may include a server for financial institution such as bank, a virtual bank, a credit union, a credit card vendor, a gift card vendor, an investment firm, or a brokerage account, as non-limiting examples. Generally, the financial institution server 106 may include any entity that holds an account, on behalf of a user, with one or more liquid assets that can be exchanged for goods and services. The one or more third party servers 108 may include business such as merchants (e.g., an entity or retailer that sells merchandise or goods), restaurants, establishment for providing accommodations (e.g., hotel), or service providers (e.g., utility provider), as non-limiting examples.

In one or more implementations, a user interacts with the electronic device 102 to initiate a payment, using the service provider server 104, in order to perform a transaction with an entity corresponding to one of the one or more third party servers 108 (e.g., the third party server 108a). In order to complete the transaction, the third party server 108a may request the service provider server 104 to provide user account data such as an account access token, an account number, and the like. The service provider server 104 may prompt the user to provide one or more account authentication credentials (e.g., username, password, and the like) for an account held by the financial institution server 106. The service provider server 104 may provide the account authentication credentials to the financial institution server 106, and if verified by the financial institution server 106, the service provider server 104 receives an access token and/or account number from the financial institution server 106 and provides the third party server 108a with access to receive funds from the account to complete the transaction. In one or more implementations, the service provider server 104 saves the account information and/or access token as a link, which may allow the user to network and to transact with another entity of the one or more third party servers 108 (e.g., third party server 108a). Beneficially, the user may not have to re-enter account credentials with the service provider server 104. This will be shown and discussed in further detail below.

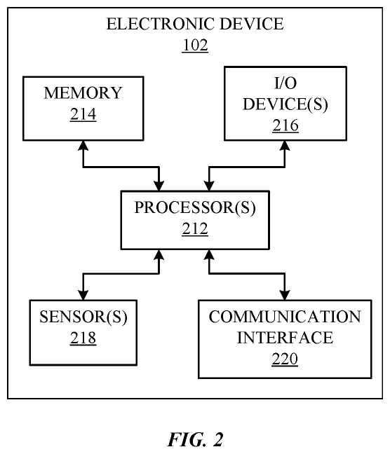

FIG. 2 illustrates an example of an electronic device 102 that may be used in a payment processing system described herein. The electronic device 102 may include any features and/or functions described herein for the electronic device 102 (shown in FIG. 1). Further, the electronic device 102 shown in FIG. 2 may be implemented in any other electronic device for use with the subject technology. Not all of the depicted components may be used in all implementations, however, and one or more implementations may include additional or different components than those shown in FIG. 2. Variations in the arrangement and type of the components may be made without departing from the spirit or scope of the claims as set forth herein. Additional components, different components, or fewer components may be provided.

The electronic device 102 may include one or more of a one or more processors 212, a memory 214, one or more input-output devices 216 (I/O DEVICE(S)), one or more sensors 218, and a communication interface 220. The one or more processors 212 may include suitable logic, circuitry, and/or code that enable processing data and/or controlling operations of the electronic device 102. In this regard, the one or more processors 212 may be enabled to provide control signals to various other components of the electronic device 102. The one or more processors 212 may also control transfers of data between various portions of the electronic device 102. The one or more processors 212 may further implement an operating system or may otherwise execute code to manage operations of the electronic device 102. The one or more processors 212 are communicatively coupled to the various components shown in FIG. 2.

The memory 214 may include suitable logic, circuitry, and/or code that enable storage of various types of information such as received data, generated data, code, and/or configuration information. The memory 214 may include volatile memory (e.g., random access memory (RAM)) and/or non-volatile memory (e.g., read-only memory (ROM), flash, and/or magnetic storage). In one or more implementations, the memory 214 may store user account data, and any other data generated in the course of performing the processes described herein.

The one or more input-output devices 216 may include a display. In one or more implementations, the display includes a capacitive touch input display, thus allowing the user to interact with the electronic device 102 by a touch input or gesture to the display. Additionally, the one or more input-output devices 216 may include one or more buttons, which may be actuated by a user. The one or more input-output devices 216, while taking the form of a display and/or buttons, may be used to provide an input to the one or more processors 212 in order to, for example, initiate a payment through a payment provider.

The one or more sensors 218 may include one or more microphones and/or cameras. The microphones may obtain audio signals, such as voice commands from a user to initiate or confirm payment processing using a payment provider. For example, the microphones may obtain audio of the user reading a passphrase or authentication code. The cameras may be used to capture images corresponding to identity data and/or credentials. For example, the cameras may capture images of a user (e.g., a selfie) for comparison against a database of images of users, may capture images of a user's identity credentials, such as driver's license, passport, etc., and/or may be used for a “liveness” determination.

The communication interface 220 may include suitable logic, circuitry, and/or code that enables wired or wireless communication, such as between the electronic device 102 and the network 110 (shown in FIG. 1). The communication interface 220 may include, for example, one or more of a Bluetooth communication interface, an NFC interface, a Zigbee communication interface, a WLAN communication interface, a USB communication interface, a cellular interface, or generally any communication interface.

In one or more implementations, the one or more processors 212, the memory 214, the one or more input-output devices 216, the one or more sensors 218, the communication interface 220, and/or one or more portions thereof may be implemented in software (e.g., subroutines and code), may be implemented in hardware (e.g., an Application Specific Integrated Circuit (ASIC)), a Field Programmable Gate Array (FPGA), a Programmable Logic Device (PLD), a controller, a state machine, gated logic, discrete hardware components, or any other suitable devices) and/or a combination of both.

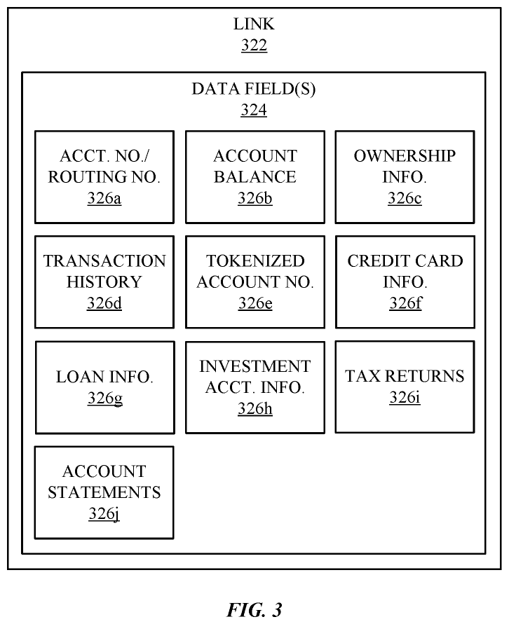

FIG. 3 illustrates exemplary data fields of example link data that may be networked by a link, in accordance with one or more implementations. Once established by a payment provider described herein, the link 322 may be networked and used in subsequent transactions with various third parties. The link 322 may correspond to one or more data fields 324. The one or more data fields 324 may be included in user account data. The following description provides several examples of the one or more data fields 324 that can be used in conjunction with the link 322. While several data fields are shown, it should be noted that the link 322 may correspond to any of the one or more data fields 324.

The one or more data fields 324 may include an account number and routing number 326a, both of which may be associated with a user account. The account number and routing number 326a may be used to provide information for a third party to receive payment from a user. The one or more data fields 324 may further include an account balance 326b (e.g., amount of currency in the account) of a user account, which may be used by an authorized third party and/or a payment provider to verify sufficient funds to complete a transaction with the third party. The one or more data fields 324 may further include ownership information 326c (e.g., name of the owner(s)) of a user account, which may be used by a third party and/or a payment provider to verify the user owns the account, implying consent to perform a transaction. The one or more data fields 324 may further include transaction history 326d of a user account, which may be used by a third party and/or a payment provider to verify whether the user has previously transacted with the third party. The one or more data fields 324 may further include tokenized account information 326e of a user account, e.g. an account access token, to replace an actual account number for increased security. The one or more data fields 324 may further include credit card information 326f (e.g., credit card balance, credit card account number, payment history) of a user account, which may be used to perform a transaction between the user and a third party.

The foregoing examples of the one or more data fields 324 may be used by a payment provider to perform a transaction with a third party on behalf of a user. Additionally, other examples of data fields that correspond to the link may be used for additional applications. For example, the one or more data fields 324 may further include loan information 326g (e.g., loan balance, loan account number, payment history) of a user account, investment account 326h (e.g., investment account balance), tax returns 326i (e.g., income tax returns), and/or account statements 326j (e.g., bank account statements). In this regard, the link 322 may be used to provide information to a third party for the purpose of loan qualification, as a non-limiting example.

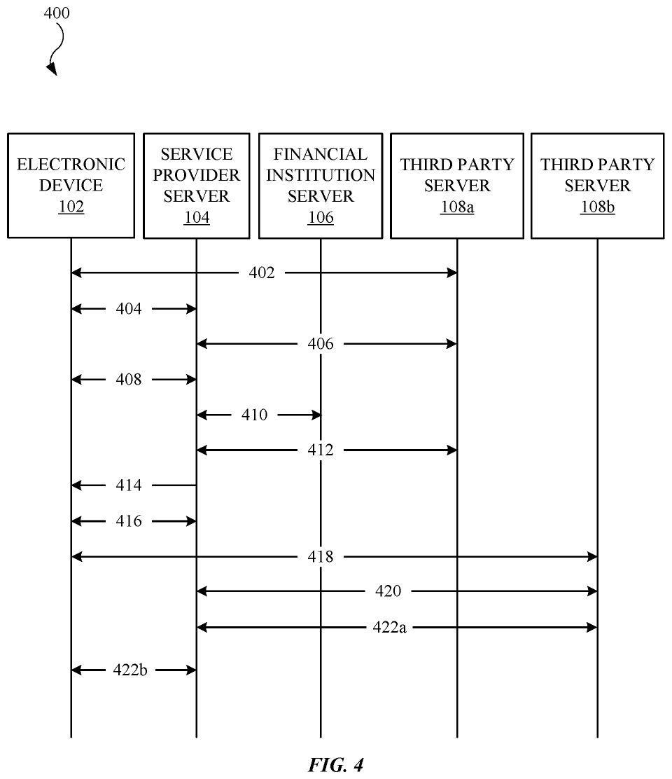

FIG. 4 illustrates an example of a process flow 400 for providing an established link to a third party. The process flow 400 includes an electronic device 102, a service provider server 104, a financial institution server 106, a third party server 108a and a third party server 108b.

At step 402, a transaction between an electronic device 102 and a third party server 108a is initiated. For example, the electronic device 102 receives instructions from a user and contacts the third party server 108a, using the electronic device 102, indicating the user desires to purchase (e.g., online purchase) something of value from the third party server 108a. In this regard, the third party server 108a may host an online merchant (as a non-limiting example) offering goods and/or services. Using the electronic device 102, the user may select one or more items and/or services to purchase from the third party server 108a, and the third party server 108a may provide information such as the cost of the item(s), a request for payment, and shipping arrangements. The information provided by the third party server 108a may be conveyed to the user by, for example, a display of the electronic device 102.

At step 404, the electronic device 102 communicates with the service provider server 104 to process a payment with the third party server 108a. The electronic device 102 receives instructions from the user and contacts the service provider server 104. They service provider server 104 may provide one or more processes to provide payment to the third party server 108a for the item(s).

At step 406, the service provider server 104 communicates with the third party server 108a. The service provider server 104 may send a request to the third party server 108a for information required to complete the transaction. The third party server 108a may respond to the request for information with a request for one or more data fields (e.g., account number and routing number of an account held by the user) required to complete the transaction.

At step 408, the service provider server 104 provides the information, received from the third party server 108a, to the electronic device 102. Further, the service provider server 104 may request from the user an account (of the user) to use for completing the transaction. The service provider server 104 may suggest the user to select an account that can provide the information required by the third party server 108a. The user may provide, via the electronic device 102, to the service provider server 104 an account (of the user) held at the financial institution server 106. In response, the service provider server 104 may request login credentials (e.g., username and password) of the account held at the financial institution server 106, e.g., if the user has not already logged into the provided account

At step 410, the service provider server 104 communicates with the financial institution server 106. The service provider server 104 provides the login credentials and may request funds (and/or verification of funds) to conduct the transaction with the third party server 108a. Upon verifying the login credentials, the financial institution server 106 provides an authorization to the service provider server 104 for the transaction.

At step 412, the service provider server 104 communicates with the third party server 108a the authorization by the financial institution server 106. In one or more implementations, the service provider server 104 provides the third party server 108a with authentication information for obtaining funds from the financial institution server 106 to complete the transaction.

At step 414, the service provider server 104 provides a notification to the electronic device 102 that the transaction was successful. The electronic device 102 may present a notification to the user indicating the successful transaction.

At step 416, the service provider server 104 notifies the user, via the electronic device 102, that the payment information received from the financial institution server 106 may be saved and stored by the service provider server 104 as a link. The link may include user account data, such as the one or more data fields, which can be used for further transactions with other authorized third parties. Moreover, the service provider server 104 may share the link with other third parties, subject to conditions, without having to provide additional requests for login credentials from the user. In response to receiving an approval from the user, via the electronic device 102, the service provider server 104 stores the link.

In step 418, a transaction between the electronic device 102 and a third party server 108b is initiated, indicating the user desires to purchase (e.g., online purchase), using the electronic device 102, something of value from the third party server 108b subsequent to transacting with the third party server 108b. In this regard, the third party server 108b may host an online merchant (as a non-limiting example) offering goods and/or services. The electronic device 102 receives instructions from the user and contacts the third party server 108b. Using the electronic device 102, the user may select one or more items and/or services to purchase from the third party server 108b, and the third party server 108b may provide information such as the cost of the item(s) or service(s), a request for payment, and shipping arrangements. The information provided by the third party server 108b may be conveyed to the user by, for example, a display of the electronic device 102.

At step 420, the third party server 108b communicates with the service provider server 104 to process a payment, on behalf of the user, with the third party server 108b. For example, the third party server 108b may communicate a server request to the service provider server 104 of the service provider server 104 to receive the user account data (e.g. one or more data fields) or at least a portion of the user account data.

Based on the ability to re-use the previously established link and the user's desire to re-use the previously established link, the process flow 400 proceeds in different manners. For example, at step 422a, the service provider server 104 communicates with the third party server 108b. The service provider server 104 may send a request to the third party server 108b for information required to complete the transaction. The third party server 108b may respond to the request for information with a request for user account data, including one or more data fields (e.g., account number and routing number of an account held by the user) required to complete the transaction.

Subject to satisfaction of each condition(s), the service provider server 104 networks the link, thus providing the third party server 108b access to the user account data to complete the transaction. In one or more implementations, for a link to be networkable, all conditions must be satisfied, with the conditions being i) the data field(s) must be permitted for networking via the link, ii) the data field(s) must be technically supported, and iii) the link cannot be broken. In some embodiments, the conditions may be associated with terms that are agreed to by an entity associated with the server 106. In some embodiments, an entity may be associated with a financial institution. Should any one of these conditions not be satisfied, the service provider server 104 will redirect the user to log into her bank account prior to attempting to transact with the third party server 108b, as discussed below. In other implementations, the conditions, including the number of conditions, may vary.

Accordingly, the link may provide access for obtaining funds from the financial institution server 106 to complete the transaction. Beneficially, the service provider server 104 effectively bypasses at least some portions of several steps (e.g., steps 408 and 410) and still completes the transaction, thus saving the user time.

Alternatively, in step 422b, the link is not used due to any one or more of the one or more conditions not being satisfied, thus preventing networking of the link. As a result, the service provider server 104 provides a user request to the user via the electronic device 102. The user request may include a request for login credentials (e.g., username and password) of the account held at the financial institution server 106. By requesting the login credentials, the service provider server 104 may request user authorization for providing the access to the user account data (e.g., one or more data fields) to, for example, transact with the third party server 108b.

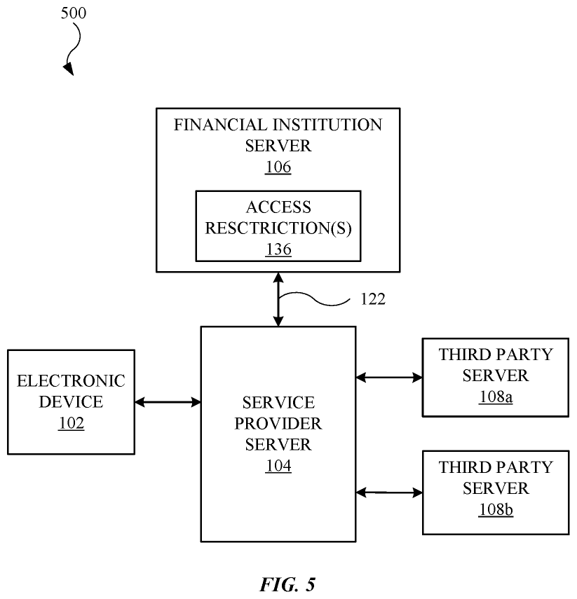

FIG. 5 illustrates a diagram 500 showing example scenarios in which a determination is made whether to network one or more data fields corresponding to a link based one various conditions. The diagram 500 includes an electronic device 102, a service provider server 104, a financial institution server 106, a third party server 108a and a third party server 108b. Although not expressly shown, the financial institution server 106, the third party server 108a and third party server 108b may each include a server used to provide a service to another computing device on behalf of a user.

In the examples shown and described with respect to the diagram 500, a user, using the electronic device 102, has completed a transaction with the third party server 108a via the service provider server 104. As a result of the transaction, the service provider server 104 generates and stores link data for a link 122, with the link data including one or more data fields associated with an account of the user held by the financial institution server 106. The link data and one or more data fields may include any one or more of the data fields 324 (shown in FIG. 3). Also, in one or more implementations, the one or more data fields may include one or more data fields requested by the third party server 108a, and subsequently provided by the financial institution server 106, to complete the transaction between the electronic device 102 (e.g., the user of the electronic device 102) and the third party server 108a, with the requested data fields being included in the link data of the link 122. Also, in one or more implementations, the one or more data fields may include data fields provided by the financial institution server 106, which may include one or more data fields in addition to those requested by the third party server 108a during a prior transaction.

In one or more implementations, a user utilizes, via the electronic device 102, the service provider server 104 to perform a transaction with the third party server 108b, representing a second third party server relative to the third party server 108a (e.g., a first third party server). The service provider server 104 may present, on the electronic device 102, an option for the user to network the link 122 with the third party server 108b (e.g., second third party server) without having to provide login credentials a second time. This may include sharing the link 122 with the third party server 108b (thus allowing access to the one or more data fields), subject to one or more conditions. For example, the financial institution server 106 may provide one or more access criteria 136 on the service provider server 104. The one or more access criteria 136 may limit or prevent at least one of the one or more data fields from being networked with the link 122. In this regard, the service provider server 104 may compare each of the one or more data fields to determine whether the service provider server 104 is authorized to share each of the one or more data fields using the link.

If, based upon the one or more access criteria 136, each of the one or more data fields is not restricted from being networked via the link 122, the service provider server 104 may network the link 122 for a transaction between the user, via the electronic device 102, and the third party server 108b. However, if at least one of the one or more data fields is restricted from being networked by the link 122, the service provider server 104 may be prevented from networking the link 122, and may provide a request to the electronic device 102 requesting the user to provide, for example, login credentials to the account held by the financial institution server 106. Subject to providing verified credentials, the service provider server 104 may provide information to the third party server 108b related to the user's account, without networking the link 122, to complete the transaction with the third party server 108b.

In one or more implementations, the link 122 is established subsequent to the transaction with the third party server 108a and includes the one or more data fields that were authorized to be used to complete the transaction with the third party server 108a, with the one or more data fields being provided by the financial institution server 106. During a transaction, when the third party server 108b requests one or more data fields that are included in the one or more previously authorized data fields, the service provider server 104 may offer the user the option to network the link 122. Put another way, when the one or more data fields requested by the third party server 108b is/are a subset of the one or more previously authorized data fields, the service provider server 104 may network the link 122 and provide the third party server 108b access to the requested data fields in the link 122. In this regard, each of the one or more data fields requested by the third party server 108b must be included in the one or more data fields. However, if any data field(s) requested by the third party server 108b is not a subset of (e.g., is not included in) the one or more data fields, the service provider server 104 may be prevented from networking the link 122, and may provide a user request to the electronic device 102 requesting the user to provide login credentials to the account held by a financial institution that manages the financial institution server 106. Subject to providing verified credentials, the service provider server 104 may provide information to the third party server 108b related to the user's account, without networking the link 122, to complete the transaction with the third party server 108b.

In one or more implementations, each data field of the one or more data fields must be a supported data field for networking via the link 122. For example, a data field is “supported” if the technical support (e.g., protocol) is in place for the service provider server 104 to integrate the data field into the link 122 for networking. For example, the technical support may require the data field(s) to be stored in a form for networking. In other words, prior to establishing the link 122 to include a data field, the data field must be technically possible by the financial institution server 106. In this regard, each of the one or more data fields requested by the third party server 108b must include a supported data field in order for the service provider server 104 to network the link 122. However, if any data field(s) requested by the third party server 108b is not a supported data field, the service provider server 104 may be prevented from using the link 122, and may provide a user request to the electronic device 102 requesting the user to provide login credentials to the account held by a financial institution that manages the financial institution server 106. Subject to providing verified credentials, the service provider server 104 may provide information to the third party server 108b related to the user's account, without networking the link 122, to complete the transaction with the third party server 108b.

In one or more implementations, the service provider server 104 may periodically (e.g., weekly, daily, hourly) perform a data pull with the financial institution server 106. The service provider server 104 may use the data pull to test (e.g., evaluate) the link 122 and determine whether any one of the one or more data fields is/are inoperable. For example, when one of the one or more data fields includes an account balance, the service provider server 104 may generate a data pull to the financial institution server 106. If the financial institution server 106 responds to the data pull with messages corresponding to “error” or “not available (N/A),” the service provider server 104 may determine the link 122 is in operable and may no longer network the link 122 in the current condition of having an inoperable data field. Alternatively, if the financial institution server 106 responds to the data pull with a number (corresponding to the purported account balance) that is unreasonably high (e.g., one quadrillion dollars), the service provider server 104 may determine the link 122 is in operable and may no longer network the link 122 in the current condition.

The service provider server 104 may not network the link 122 to the third party server 108b for any one of the aforementioned conditions is not satisfied. Moreover, the service provider server 104 may not network the link unless each and every issue is satisfied or subsequently resolved prior to linking. Put another way, the service provider server 104 may self-authorize and apply the most restrictive set of circumstances such that any and all conditions are satisfied prior to networking the link 122.

In some instances, the service provider server 104 may detect any one or more issues and proactively attempt to resolve the issue(s) before the user engages the service provider server 104 for a transaction. For example, subsequent to detecting an error based on a data pull, the service provider server 104 may communicate with the financial institution server 106 and attempt to resolve the issue (e.g., fix a previously inoperable data field). Alternatively, the service provider server 104 may communicate to the electronic device 102 a request to enter the user's login credentials to the account held by a financial institution that manages the financial institution server 106. Still further, the service provider server 104 may communicate to the electronic device 102 a request to the user to select either another account held by either the financial institution server 106 or another financial institution.

As another example, subject to determining that the third party server 108b requires one or more additional data fields (making the data fields requested by the third party server 108b not a subset of the one or more data fields), the service provider server 104 may communicate to the electronic device 102 a request to enter the user's login credentials to the account held by the financial institution server 106 and obtain the additional data field(s) from the financial institution server 106. After obtaining the additional data field(s), the service provider server 104 may update the link data of the link 122 with the additional data field(s) or may generate a new link with the additional data fields for use with the third party server 108b. Beneficially, by proactively fixing issues prior to an attempted transaction between the user and the third party server 108b, the service provider server 104 may enhance the overall experience of the transaction by, for example, reducing the amount of time and required steps required by the user to complete the transaction.

Subject to user approval, in one or more implementations, third party servers described herein may use a service provider server described herein in a variety of applications. For example, a third party server may use a service provider server to verify and retrieve permissioned data from one or more financial institutions. In another example, a third party may sever may obtain user data in the form of cash flow information, income information, and spending habit information to build financial management tools or to offer financial service to the user. Moreover, a third party server may use the obtained information to mitigate the risk of losses when processing payments or providing financial services. Still further, in one or more implementations, a third party server may use a service provider server to assist users in paying bills and manage business-related expenses (e.g., payroll). Accordingly, with user approval, service provider servers described herein may offer benefits in the form of streamlining account verification and data sharing.

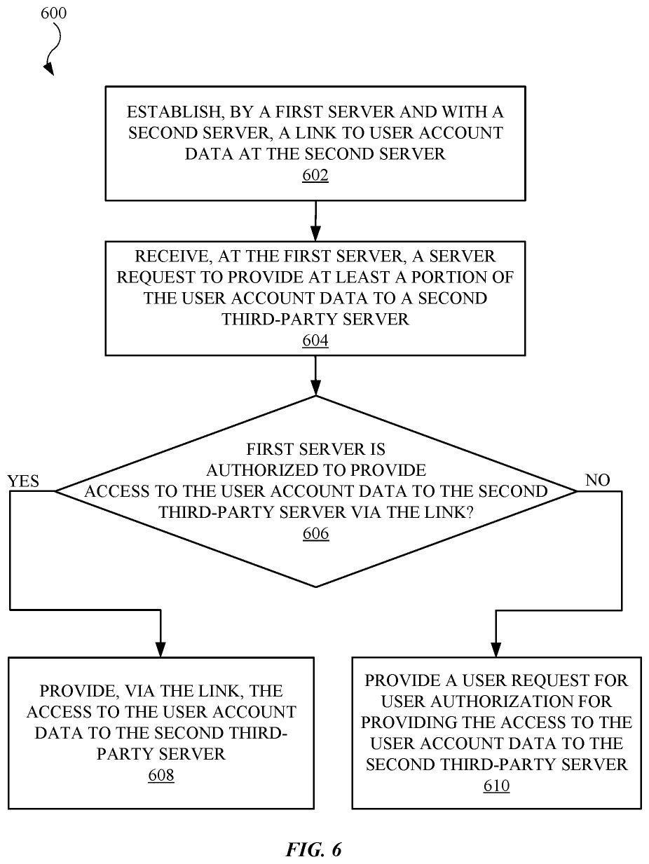

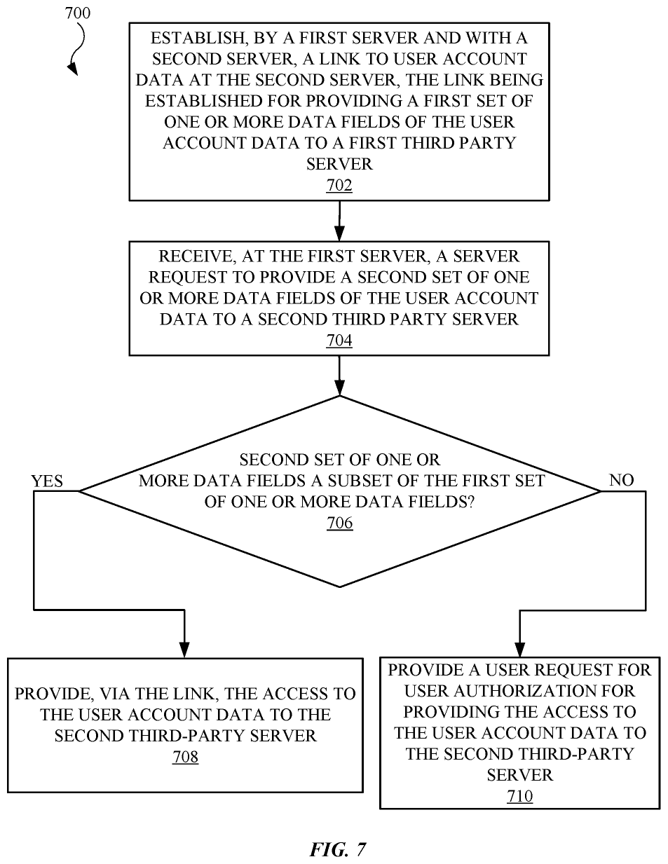

FIG. 6 and FIG. 7 illustrate respective flowcharts showing various processes that may be conducted by a payment provider, including a server of the payment provider, shown and/or described herein. The processes shown in the flowcharts may be conducted by a non-transitory computer-readable medium used with a payment provider described herein.

FIG. 6 illustrates a flowchart 600 showing a method for managing a transaction between an electronic device 102 and one or more third party servers 108 (e.g., third party server 108a through third party server 108n), both shown in FIG. 1. In step 602, a link by a first server and with a second server is established. In one or more implementations, the first server is associated with the payment provider. Also, in one or more implementations, the second server is associated with the financial institution. The link may provide a connection to user account data at the second server. Also, the link may be established for providing the user account data to a first third party server. The first third party server may be associated with a first business (e.g., first merchant) with which a user desires to transact. Also, the link may be associated with one or more rules, which may include conditions such as one or more access restrictions.

In step 604, a server request is received at the first server. The server request may include a request to provide at least a portion of the user account data to a second third party server. The second third party server may be associated with a second business (e.g., second merchant) with which a user desires to subsequently transact.

In step 606, a determination is made whether the first server is authorized to provide access to the user account data to the second third party server via the link. In one or more implementations, the determination is based on the one or more rules, such as the one or more access restrictions.

In step 608, in response to determining that the first server is authorized to provide the access via the link, the first server may provide the access to the user account data to the second third party server.

In step 610, in response to determining that the first server is not authorized to provide the access via the link, the first server may provide a user request for user authorization for providing the access to the user account data to the second third party server.

FIG. 7 illustrates a flowchart 700 showing an alternate process for managing a transaction between an electronic device 102 and one or more third party servers 108 (e.g., third party server 108a through third party server 108n), both shown in FIG. 1. In step 702, a link by a first server and with a second server is established. In one or more implementations, the first server is associated with the payment provider. The first third party server may be associated with a first business (e.g., first merchant) with which a user desires to transact. Also, in one or more implementations, the second server is associated with the financial institution. The link may include a connection to user account data at the second server. Also, the link being established for providing a first set of one or more data fields of the user account data to a first third party server. In one or more implementations, the link is associated with one or more access restrictions.

In step 704, a server request is received at the first server. The server request may include a request to provide a second set of one or more data fields of the user account data to a second third party server. The second third party server may be associated with a second business (e.g., second merchant) with which a user desires to subsequently transact.

In step 706, a determination is made whether the second set of one or more data fields is a subset of the first set of one or more data fields. In one or more implementations, the determination is based on the one or more access restrictions.

In step 708, in response to determining that the second set of one or more data fields is in the subset of the first set of one or more data fields, the first server may provide, via the link, the access to the user account data to the second third party server.

In step 710, in response to determining that the second set of one or more data fields is not in the subset of the first set of one or more data fields, the first server may provide a request to a user of the user account data for user authorization for providing the access to the user account data to the second third party server.

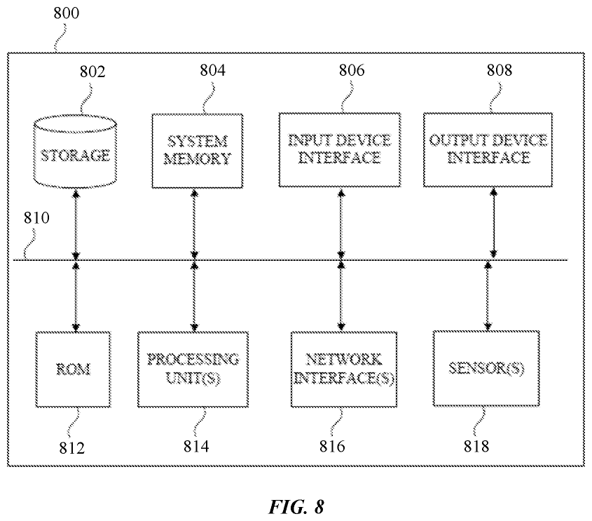

FIG. 8 illustrates an example electronic system with which aspects of the present disclosure may be implemented, in accordance with one or more implementations. The electronic system 800 can be, and/or can be a part of, any server for generating the features and processes described in reference to FIGS. 1-7, including but not limited to a server. The electronic system 800 may include various types of computer-readable media and interfaces for various other types of computer-readable media. The electronic system 800 includes one or more processing unit(s) 814, a persistent storage device 802, a system memory 804 (and/or buffer), an input device interface 806, an output device interface 808, a bus 810, a ROM 812, one or more processing unit(s) 814, one or more network interface(s) 816, one or more sensor(s) 818, and/or subsets and variations thereof.

The bus 810 collectively represents all system, peripheral, and chipset buses that communicatively connect the numerous internal devices of the electronic system 800. In one or more implementations, the bus 810 communicatively connects the one or more processing unit(s) 814 with the ROM 812, the system memory 804, and the persistent storage device 802. From these various memory units, the one or more processing unit(s) 814 retrieves instructions to execute and data to process in order to execute the processes of the subject disclosure. The one or more processing unit(s) 814 can be a single processor or a multi-core processor in different implementations.

The ROM 812 stores static data and instructions that are needed by the one or more processing unit(s) 814 and other modules of the electronic system 800. The persistent storage device 802, on the other hand, may be a read-and-write memory device. The persistent storage device 802 may be a non-volatile memory unit that stores instructions and data even when the electronic system 800 is off. In one or more implementations, a mass-storage device (such as a magnetic or optical disk and its corresponding disk drive) may be used as the persistent storage device 802.

In one or more implementations, a removable storage device (such as a floppy disk, flash drive, and its corresponding disk drive) may be used as the persistent storage device 802. Like the persistent storage device 802, the system memory 804 may be a read-and-write memory device. However, unlike the persistent storage device 802, the system memory 804 may be a volatile read-and-write memory, such as RAM. The system memory 804 may store any of the instructions and data that one or more processing unit(s) 814 may need at runtime. In one or more implementations, the processes of the subject disclosure are stored in the system memory 804, the persistent storage device 802, and/or the ROM 812. From these various memory units, the one or more processing unit(s) 814 retrieves instructions to execute and data to process in order to execute the processes of one or more implementations.

The bus 810 also connects to the input device interfaces 806 and output device interface 808. The input device interface 806 enables a user to communicate information and select commands to the electronic system 800. Input devices that may be used with the input device interface 806 may include, for example, alphanumeric keyboards, touch screens, and pointing devices. The output device interface 808 may enable the electronic system 800 to communicate information to users. For example, the output device interface 808 may provide the display of images generated by electronic system 800. Output devices that may be used with the output device interface 808 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 810 also couples the electronic system 800 to one or more networks and/or to one or more network nodes through the one or more network interface(s) 816. In this manner, the electronic system 800 can be a part of a network of computers (such as a local area network, a wide area network, an Intranet, or a network of networks, such as the Internet). Any or all components of the electronic system 800 can be used in conjunction with the subject disclosure.

Finally, as shown in FIG. 8, the bus 810 also connects to sensor(s) 918. The sensor(s) 918 may include one or more components for capturing data, such as audio and/or image data. The captured data may be used for enrolling in a credential, validating a credential, accessing a service, and/or any other process for establishing the identity of the user.

Implementations within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
establishing, by a first server and with a second server, a link to user account data at the second server, the link being established for providing the user account data to a first third party server, wherein the link is associated with one or more access criteria;
receiving, at the first server, a server request to provide at least a portion of the user account data to a second third party server;
in response to determining, based on at least the one or more criteria being satisfied, providing access to the user account data to the second third party server via the link;
in response to determining that the first server is authorized based on the one or more criteria being satisfied, providing, via the link, the access to the user account data to the second third party server; and
in response to determining that the first server is not authorized, providing a user request for user authorization for providing the access to the user account data to the second third party server.

2. The method of claim 1, wherein providing the user request comprises displaying a prompt for a user to provide login credentials for accessing the user account data.

3. The method of claim 1, wherein determining whether the first server is authorized to provide the access to the user account data to the second third party server via the link comprises:
determining, based on the one or more access criteria, whether one or more data fields of the user account data are restricted for sharing via the link;
in response to each of the one or more data fields not being restricted for sharing via the link, providing, via the link, the one or more data fields to the second third party server; and
in response to at least one of the one or more data fields being restricted for sharing via the link, providing the user request.

4. The method of claim 3, wherein the one or more data fields corresponds to the portion of the user account data from the received server request.

5. The method of claim 3, wherein the one or more data fields comprises at least one of a balance of a user account associated with the user account data, an account number of the user account, a transaction history of the user account, or ownership information of the user account.

6. The method of claim 1, wherein determining whether the first server is authorized to provide the access to the user account data to the second third party server via the link comprises:
determining whether one or more data fields of the user account data are supported for sharing via the link;
in response to each of the one or more data fields i) being supported for sharing and ii) not being restricted based on the one or more access criteria being satisfied, providing, via the link, the access to the one or more data fields to the second third party server; and
in response at least one of the one or more data fields i) not being supported for sharing or ii) being restricted based on the one or more access criteria, providing the user request.

7. The method of claim 1, wherein determining whether the first server is authorized to provide the access to the user account data to the second third party server via the link comprises:
obtaining, based on the server request, a first set of account data of the user account data, wherein the first set of account data is used to establish the link with the first third party server;
obtaining, based on the server request, a second set of account data of the user account data; and
comparing the first set of account data with the second set of account data.

8. The method of claim 7, wherein:
in response to determining that the second set of account data is a subset of the first set of account data, providing, via the link, the access to the user account data to the second third party server, and
in response to determining that the second set of account data is not a subset of the first set of account data, providing the user request.

9. The method of claim 1, further comprising, subsequent to establishing the link:
performing, by the first server, a data pull to test the link; and
in response to determining, based on the data pull, the link is inoperable, providing the user request.

10. A system comprising:
a memory; and
a processor configured to:
establish, by a first server and with a second server, a link to user account data at the second server, the link being established for providing a first set of one or more data fields of the user account data to a first third party server, wherein the link is associated with one or more access restrictions;
receive, at the first server, a server request to provide a second set of one or more data fields of the user account data to a second third party server;
determine, based on at least the one or more access restrictions, whether the second set of one or more data fields is a subset of the first set of one or more data fields;
in response to determining that the second set of one or more data fields is in the subset of the first set of one or more data fields, provide, via the link, access to the user account data to the second third party server; and
in response to determining that the second set of one or more data fields is not in the subset of the first set of one or more data fields, provide a request to a user of the user account data for user authorization for providing the access to the user account data to the second third party server.

11. The system of claim 10, wherein the processor is further configured to provide the request by displaying a prompt for a user to provide login credentials for accessing the user account data.

12. The system of claim 10, wherein the processor is further configured to:
determine, based on the one or more access restrictions, whether one or more data fields of the user account data are restricted for sharing via the link;
in response to each of the one or more data fields not being restricted for sharing via the link, provide, via the link, the one or more data fields to the second third party server; and
in response to at least one of the one or more data fields being restricted for sharing via the link, provide the request.

13. The system of claim 10, wherein the processor is further configured to:
determine whether one or more data fields of the user account data are supported for sharing via the link;
in response to each of the one or more data fields i) being supported for sharing and ii) not being restricted based on the one or more access restrictions, provide, via the link, the access to the one or more data fields to the second third party server; and
in response at least one of the one or more data fields i) not being supported for sharing or ii) being restricted based on the one or more access restrictions, provide the request.

14. The system of claim 10, wherein the processor is further configured to:
obtain, based on the server request, a first set of account data of the user account data, wherein the first set of account data is used to establish the link with the first third party server;
obtain, based on the server request, a second set of account data of the user account data; and
compare the first set of account data with the second set of account data.

15. The system of claim 14, wherein the processor is further configured to:
in response to determining that the second set of account data is a subset of the first set of account data, provide, via the link, the access to the user account data to the second third party server, and
in response to determining that the second set of account data is not a subset of the first set of account data, provide the request.

16. A non-transitory computer-readable medium, comprising:
computer-readable instructions that, when executed by a processor, cause the processor to perform one or more operations comprising:
establishing, by a first server and with a second server, a link to user account data at the second server, the link being established for providing the user account data to a first third party server;
receiving, at the first server, a server request to provide at least a portion of the user account data to a second third party server;
determining, based on one or more rules, whether the first server is authorized to provide access to the user account data to the second third party server via the link;
in response to determining that the first server is authorized, providing, via the link, the access to the user account data to the second third party server; and
in response to determining that the first server is not authorized, providing a user request for user authorization for providing the access to the user account data to the second third party server.

17. The non-transitory computer-readable medium of claim 16, wherein the one or more rules are selected from at least one of:
one or more access restrictions from a financial institution associated with the second server,
one or more data fields of the user account data being supported by the link, or
one or more data fields of the user account data being operable based on a data pull from the link.

18. The non-transitory computer-readable medium of claim 16, wherein determining whether the first server is authorized to provide the access to the user account data to the second third party server via the link comprises:
determining, based on the one or more rules, whether one or more data fields of the user account data are restricted for sharing via the link;
in response to each of the one or more data fields not being restricted for sharing via the link, providing, via the link, the one or more data fields to the second third party server; and
in response to at least one of the one or more data fields being restricted for sharing via the link, providing the user request.

19. The non-transitory computer-readable medium of claim 16, wherein determining whether the first server is authorized to provide the access to the user account data to the second third party server via the link comprises:
determining whether one or more data fields of the user account data are supported for sharing via the link;
in response to each of the one or more data fields i) being supported for sharing and ii) not being restricted based on the one or more rules, providing, via the link, the access to the one or more data fields to the second third party server; and
in response at least one of the one or more data fields i) not being supported for sharing or ii) being restricted based on the one or more rules, providing the user request.

20. The non-transitory computer-readable medium of claim 16, wherein determining whether the first server is authorized to provide the access to the user account data to the second third party server via the link comprises:
obtaining, based on the server request, a first set of account data of the user account data, wherein the first set of account data is used to establish the link with the first third party server;
obtaining, based on the server request, a second set of account data of the user account data; and
comparing the first set of account data with the second set of account data.
